(19) United States
(12) Patent Application Publication
(10) Pub. No.: US 2021/0024263 A1
(43) Pub. Date: Jan. 28, 2021

(54) RETRACTABLE CAULKING CAP

(71) Applicant: Diarmuid Griffin, Woodland Hills, CA (US)

(72) Inventor: Diarmuid Griffin, Woodland Hills, CA (US)

(21) Appl. No.: 17/068,705

(22) Filed: Oct. 12, 2020

Related U.S. Application Data
(63) Continuation-in-part of application No. 16/525,405, filed on Jul. 29, 2019.
(60) Provisional application No. 62/711,583, filed on Jul. 29, 2018.

(51) Int. Cl. B65D 55/16; B05C 17/005; B65D 41/02

(52) U.S. Cl. CPC B65D 55/16; B65D 41/02; B05C 17/0052

(57) ABSTRACT

A caulking gun housing system, configured to retain a caulking gun, is disclosed. The caulking gun housing system includes a securing frame configured to retain an upper end of a caulking gun. The caulking gun housing system includes a retaining frame configured to retain a lower end of the caulking gun. The caulking gun housing system includes a holstering device configured to be secured to a user.

### CROSS REFERENCE TO RELATED APPLICATIONS

This application claims priority from provisional patent application 62/711,583, filed on Jul. 29, 201, which is incorporated by reference herein. This application further claims priority from non-provisional application Ser. No. 16/525,405, as a continuation-in-part application.

### FIELD OF THE INVENTION

The present invention relates generally to the field of construction tool accessories, and more particularly to a retractable cap for a nozzle of a caulking tube retained in a caulking gun.

### BACKGROUND

A caulk gun is used to seal off unwanted cracks in places like windows and bathtubs. This seal is created with a bead of waterproof filler, that can help prevent mold, leaks and bugs from creating unwanted issued within a home. In some instances, when used for windows, caulking can prevent less air from passing through the cracks around unsealed windows and doors, ultimately leading to lower energy costs.

The caulking gun is often used as a tool that holds a tube or cartridge that's filled with material used for sealing up the gaps and cracks in a home or structure. The caulking can be made of silicone or latex, and is often used to bond a wide range of materials like metal, glass, wood and ceramic. Being that caulk usually comes in a tube, a caulking gun is used to get the caulk out of the tube, smoothly, with enough application, and with the ability to control and regulate how much caulk comes out of the tube at one time. Typically, the dispensing of caulk and adhesive comprises of the caulk gun in combination with a plastic or cardboard cylindrical canister or tube which is filled with caulk or adhesive. Typically, in order to load a caulking gun, the caulking tube is loaded into the frame of the caulking gun, with the nozzle facing away from the user. Once the caulk tube is sitting securely inside the frame, a metal rod is used to contact the back of the caulking tube in order to push the caulking out of the nozzle. The triggering device interacts with the metal rod in order to ensure the caulking gun releases the caulk at the speed and thickness desired. Hereinafter, reference will be made to caulk and caulk tubes, but it should be noted that the reference is intended to encompass both caulk and adhesives.

Often the user of the caulking gun or a caulking system needs to continuing adjusting or working in their work area without the need of the caulking gun. During these times, the caulking gun can get in the way, or not be immediately available if there is a project that immediately needs caulking to be applied. As such, there is a long felt need for a caulking gun system that is able to make the caulking gun readily available, protect the caulking gun from any damage, while also preventing any leaking material from the caulking gun from getting into the work area where undesired. Accordingly, the front end of the nozzle is opened so that the caulking material is dispensed though the front opening in the nozzle. A cap is placed over the front of the nozzle to prevent the contents from leaking out of the caulking tube.

As discussed above, in operation, the cap is often removed and the caulking gun is operated by squeezing a trigger portion which pushes the back wall into the caulking tube to squeeze the contents out of the front opening in the nozzle. As the trigger is activated, the ratchet mechanism advances the back wall into the caulking tube interior to compress and force the caulking material from the interior. As such, the problem addressed by the present invention is retaining the cap after it is removed from the nozzle. A user may place the cap on a surface and forget where the cap was placed, or the cap may roll away and be lost. Therefore, in combination with protecting the caulking gun and make it readily available, preventing unnecessary leakage is accomplished by the present disclosure.

### SUMMARY

Accordingly, a caulking gun housing system, configured to retain a caulking gun, is disclosed. The caulking gun housing system includes a securing frame configured to retain an upper end of a caulking gun. The caulking gun housing system includes a retaining frame configured to retain a lower end of the caulking gun. The caulking gun housing system includes a holstering device configured to be secured to a user.

In one embodiment, the securing frame is configured to be slideably attached to the retaining frame.

In one embodiment, the securing frame is configured to removably attach to the retaining frame via a plurality of rivets configured to insert into one or more rivet holes in the retaining frame.

In one embodiment, each of the plurality of rivets are positioned underneath the securing frame.

In one embodiment, the retaining frame is configured to be joined to be continuously joined to the securing frame.

In one embodiment, the securing frame is a tubular shape.

In one embodiment, the retaining frame is a tubular shape.

In one embodiment, the holstering device is configured to be removably attached to a belt or belt loop via a latch and hook style holster.

In one embodiment, the retaining frame comprises of an open portion and a closed portion.

In one embodiment, the open portion is flush with the securing portion.

In one embodiment, the closed portion further comprises an enclosed portion configured to protect a nozzle of a caulking gun.

In one embodiment, the closed portion further comprises a cap configured to prevent drippage from the nozzle of the caulking gun from leaking.

In one embodiment, a secondary retaining device is configured to retain a caulking tube retained in the caulking gun, or removed from the caulking gun.

In one embodiment, the retaining frame comprises of a plurality of cord holes, configured to receive and retain a tie cord.

In one embodiment, tie cord comprises of two ends configured to be tied around the leg of a user.

In one embodiment, the tie cord is a flexible cord comprising of material selected from one or more of a cord, a rope, nylon, a metal strip, a plastic strip.

In one embodiment, the securing frame is configured to secure a metal rod attached to the upper end of the caulking gun.

In one embodiment, the securing frame is configured to attach to the metal rod of the caulking gun using an adhesive. The securing frame is configured to attach to the metal rod of the caulking gun using a magnet. The securing frame is configured to attach to the metal rod of the caulking gun using a structural integration selected from one or more of welding or molding.

In one embodiment, the securing frame is configured to attach to the metal rod of the caulking gun using rivets. The securing frame is configured to attach to the metal rod of the caulking gun using buttons. The securing frame is configured to attach to the metal rod of the caulking gun using snaps.

In one embodiment, the securing frame is configured to attach to the metal rod of the caulking gun using a spring clip. The securing frame is configured to attach to the metal rod of the caulking gun using a press fit device.

This summary is provided merely for purposes of summarizing some example embodiments, so as to provide a basic understanding of some aspects of the subject matter described herein.

Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

Disclosed herein are embodiments of an interchangeable double-sided attachment for an article. This description includes drawings, wherein:

FIG. 1 is a perspective view of the caulking gun housing system, in accordance with an example;

FIG. 2 is an exploded view of the caulking gun housing system, in accordance with an example;

FIG. 3 is a side view of the caulking gun housing system, in accordance with an example;

FIG. 4 is a top perspective view of the present invention caulking gun retractable member with the nozzle cap in the retracted condition;

FIG. 5 is a side perspective view of the present invention caulking gun retractable cap in the retracted condition;

FIG. 6 is a cross-sectional view of the housing member including the interior of the housing member, the coil spring retraction member and the flexible cord affixed to the retraction member at a proximal end and affixed to a cap (illustrated in a side-perspective view) at the distal end at the flexible cord;

FIG. 7 is a top plan view of the interior of the cap portion of the present invention retractable cap of a caulking tube placed in a caulking gun;

FIG. 8 is a side perspective view of the present invention caulking tube retractable cap in the extended position away from the housing which is removably affixed to a portion of a caulking gun adjacent the trigger;

FIG. 9 is an exploded perspective view of the present invention caulking tube retractable cap separated from the caulking tube within a caulking gun with the clip portion of the present invention housing affixed to a rear sidewall of the caulking gun and the retractable cap extended beyond the location of the nozzle of a caulking tube retained in a caulking gun; and

FIG. 10 is a perspective view of the present invention caulking gun retractable cap with the clip portion affixed to a rear sidewall of the caulking gun and the retractable cap extended and fitting on the nozzle of a caulking tube retained in the caulking gun.

Elements in the figures are illustrated for simplicity and clarity and have not been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

The invention may be embodied in other specific forms without departing from the spirit of essential characteristics thereof. The present embodiments therefore to be considered in all respects as illustrative and not restrictive, the scope of the invention being indicated by the appended claims rather than by the foregoing description, and all changes which come within the meaning and range of equivalency of the claims are therefore intended to be embraced therein.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The numerous innovative teachings of the present application will be described with particular reference to presently preferred embodiments (by way of example, and not of limitation). The present application describes several inventions, and none of the statements below should be taken as limiting the claims generally.

In the following discussion, numerous specific details are set forth to provide a thorough understanding of the present disclosure. However, those skilled in the art will appreciate that embodiments may be practiced without such specific details. Furthermore, lists and/or examples are often provided and should be interpreted as exemplary only and in no way limiting embodiments to only those examples.

Exemplary embodiments are described below in the accompanying Figures. The following detailed description provides a comprehensive review of the drawing Figures in order to provide a thorough understanding of, and an enabling description for, these embodiments. One having ordinary skill in the art will understand that in some cases well-known structures and functions have not been shown or described in detail to avoid unnecessarily obscuring the description of the embodiments.

Accordingly, a caulking gun housing system, configured to retain a caulking gun, is disclosed. The caulking gun housing system includes a securing frame configured to retain an upper end of a caulking gun. The caulking gun housing system includes a retaining frame configured to retain a lower end of the caulking gun. The caulking gun housing system includes a holstering device configured to be secured to a user.

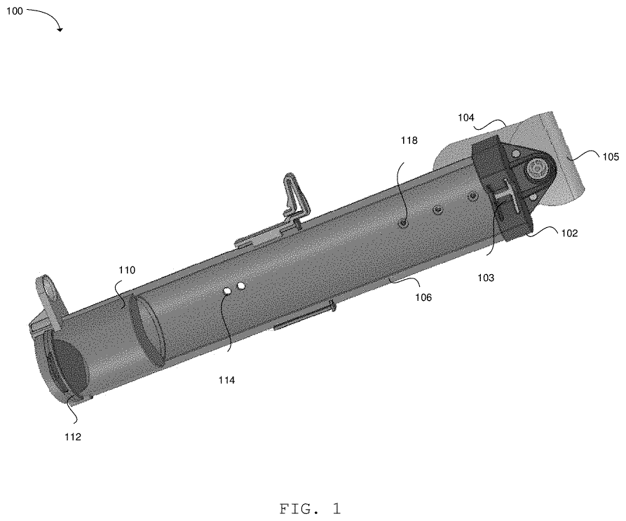

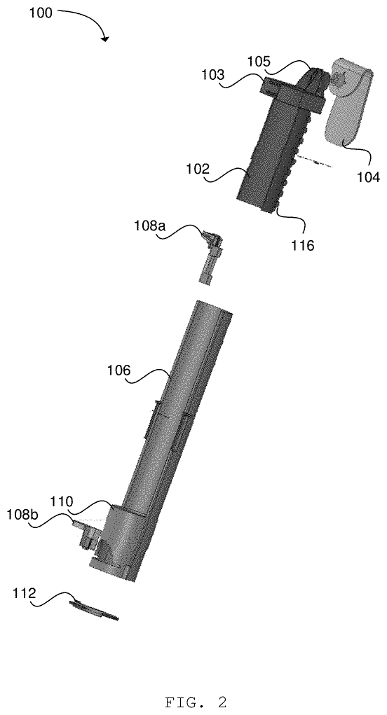

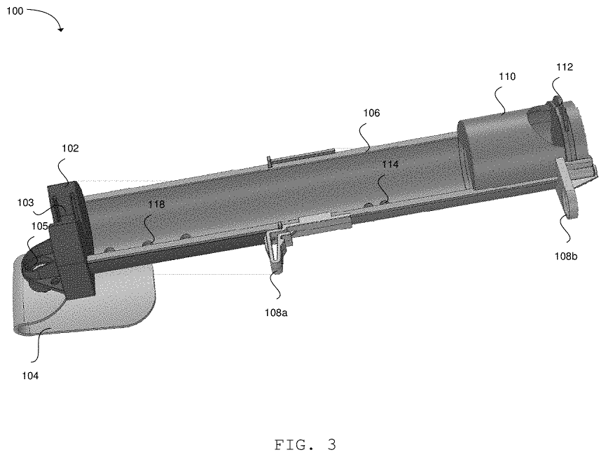

Referring now to FIG. 1-3, each of the figures depicts a caulking gun housing system 100. The caulking gun housing system 100 is configured to retain a caulking gun within the frame of the caulking gun housing system. The frame of the caulking gun housing system is tubular in shape, or in a shape similar enough to the shape of the tube of the caulking gun, in order to ensure a close housing fit. Accordingly, the caulking gun system includes a securing frame 102 configured to retain an upper portion of a caulking gun that is inserted into the frame. The securing frame 102 includes a retaining device that is configured to retain an upper portion of the caulking gun and more specifically, the metal rod extending from the trigger of the caulking gun. The retaining portion 103 can be a press fit device that is configured to have the metal rod press fitted into the press fit receptacle. Once the metal rod is press fitted into the receptacle, the press fit device includes two arms that are tightly fit in order to ensure the metal rod does not inadvertently slip from the receptacle.

In one embodiment, the securing frame 102 is configured to attach to the metal rod of the caulking gun using one or more of an adhesive, a magnet, or a structural integration. In some instances, the structural integration can be one or more of welding or molding.

In one embodiment, the securing frame 102 is configured to attach to the metal rod of the caulking gun using one or more of rivets, buttons, or snaps.

In one embodiment, the securing frame 102 is configured to attach to the metal rod of the caulking gun using a spring clip.

The securing frame 102 further includes a holster retaining device 105 that comprises of central pivot. The central pivot 105 comprises of one or more of a ball and joint. Either of the ball and joint can be configured to be attached to one or more of the holster 104 or the securing frame 102. The ball and joint are configured to be removably attached and configured to rotate in a 360-degree angle about the central pivot o the retaining device 105.

The securing frame 102 further comprises of a plurality of rivets or insertion 116 on the underbody of the tubular securing frame 102. The rivets are configured to be inserted into one or more hollow rivet receiving holes 114 in the retaining frame 106. The rivet receiving holes 114 are configured to receive the plurality of inserts or rivets 116 and secure the securing frame 102 to the retaining frame 106 accordingly. As such, the securing frame 102 is flush with the retaining frame 106, creating a continuous tubular frame for the caulking gun to be housed. The continuous tubular frame is created via the open end of the retaining frame 106, whereas the opposite end of the retaining frame 106 comprises of a closed off end 110. In one embodiment, the securing frame 102 can be slidably adjusted and inserted in one or more of the plurality of rivets receiving holes in order to adjust the size of the continuous tubular frame relative to the retaining frame 102, being positioned within the securing frame 106.

The closed off end 110 of the retaining frame 106 is configured to retain the nozzle end of the caulking gun within an enclosure. The enclosure of the closed off end 110 is further configured to protect and preserve the integrity of the nozzle, in order to ensure that the nozzle remains undamaged, and able to efficiently insert caulking where the user desires. The closed off end 110 further includes a cap 112, that is removably inserted into a slot within the enclosure 110. The cap 112 can be removed for cleaning and easily replaced back into the slot in order to catch any drippage or spillage that could come from the nozzle after usage of the caulking gun by the user. Often times, a caulking gun can be utilized by the user and immediately replaced back into the frame of the securing frame 102 and the retaining frame 106. In order to avoid mess, or drippage of caulking from contaminating various work areas, the cap 112 can be utilized to ensure a clean workspace, that is clear of unwanted caulk.

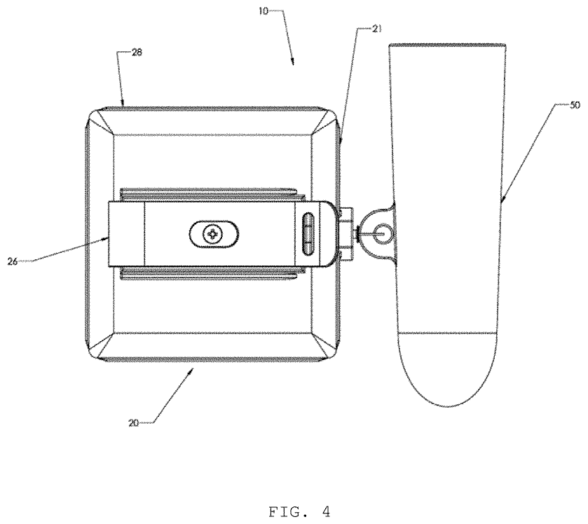

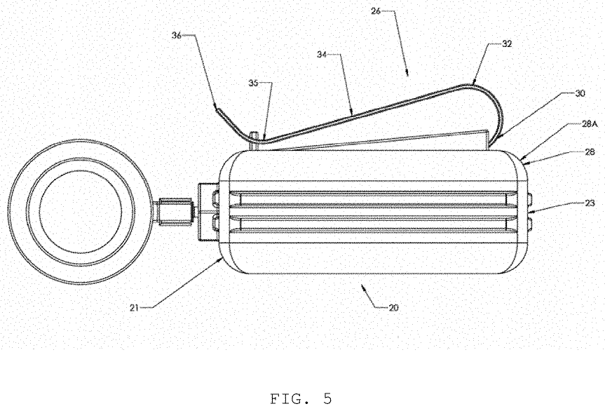

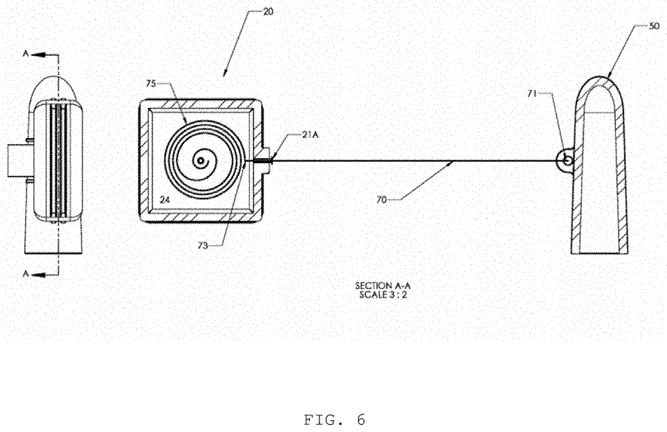

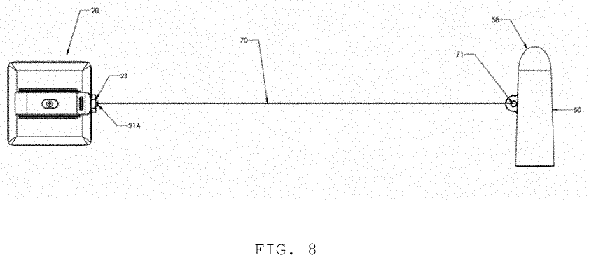

The retaining frame 106 further includes a secondary retaining device 108 comprising of a first portion 108a and a second portion 108b. The secondary retaining device 108 is configured to receive and retain a second or spare caulking tube, or a removed caulking tube of the caulking gun retained in the retaining device 100. Accordingly, the first portion 108a is configured to contact the top portion of the caulking tube, and the second portion 108b is configured to receive the nozzle of the caulking tube. The second portion 108b is configured to receive the caulking tube nozzle within a slot, that will secure the nozzle in place. The first portion 108a is configured to adjust to press fit the caulking tube to ensure that it is secured within the secondary retaining device 108.

[Referring to FIGS. 4, 5, 6, 7, and 8, caulking gun retractable cap 10 comprises a housing portion 20, a cap portion 50, and a flexible cord 70. As depicted in FIG. 4 and FIG. 5, housing portion 20 has a housing front vertical wall 21 and a housing rear vertical wall 23. As shown by FIG. 6, in the cross-sectional view of housing portion 20, the housing front vertical wall 21 has a front vertical wall opening 21A that leads into housing interior chamber 24, which contains a retraction member 75, such as a coiled spring 75, affixed to a proximal end 73 of the flexible cord 70. A distal end 71 of flexible cord 70 attaches to a closed end 58 of a cap 50 as depicted in FIG. 8.

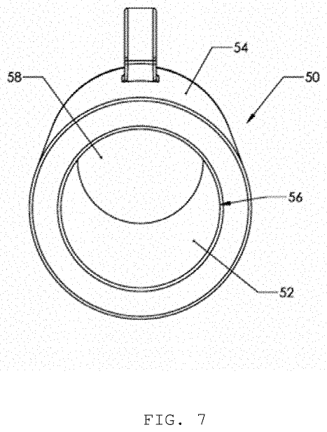

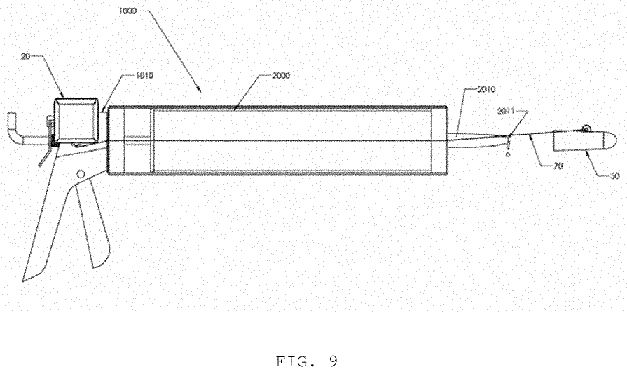

As depicted in FIG. 7, cap 50 has an interior chamber 52 surrounded by a cylindrical vertical wall 54. Cap vertical wall 54 further contains a cap opening 56 at one end of cylindrical vertical wall 54, and further contains enclosed cap end 58 opposite to the cap opening 56 as also depicted in FIG. 8. Interior chamber 52 is sized to receive a tip of a nozzle 2010 of a caulking tube 2000 (illustrated in FIG. 9).

Referring back to FIG. 9, housing portion 20 includes on exterior sidewall 28 a spring clip 26 for clipping the housing portion 20 to a caulking gun 1000. Although as depicted, a spring clip 26 is used, the spring clip 26 may be replaced by one or more strong magnets to attach housing portion 20 to caulking gun 1000. Other methods can be used to affix the housing portion 20 to caulking gun 1000, or the housing portion 20 may be integrated into the caulking gun 1000.

Referring to FIGS. 5 and 4, and more particularly to FIG. 5, as depicted, housing portion 20 includes spring clip 26 affixed to at least one of the housing exterior sidewalls 28. Spring clip 26 has a first clip vertical wall 30 that is flush and parallel with at least one of the housing exterior sidewalls 28. First clip vertical wall 30 is retained within at least one housing exterior sidewall opening 28A. First clip vertical wall 30 extends towards housing rear vertical wall 23 and contains an approximate 180 degree curve 32 to form a second clip vertical wall 34 that extends at a downward angle towards at least one of the housing exterior sidewalls 28 until reaching a connection point 35 to contact either housing exterior sidewall 28 or first clip vertical wall 30 and then extend slightly upward for a distance 36. As noted earlier, spring clip 26 can be replaced by one or more strong magnets.

Referring again to FIGS. 5 and 9, in operation connection point 35 of spring clip 26 is extended outwardly to form a gap prior to placing housing portion 20 of the present invention caulking gun retractable cap 10 over a caulking tube nozzle 2010 (illustrated in FIG. 9). The spring clip 26 can be clipped onto the caulking gun 1000 proximate to a caulking tube retention 1010.

Referring again to FIGS. 4, 5, 6, 7, and 8, and more particularly to FIG. 6, as depicted, housing portion 20 includes housing interior chamber 24 containing coil spring 75 for retracting flexible cord 70. As depicted in FIG. 6, coil spring 75 can be connected with proximal end 73 of the flexible cord 70 to wind and unwind around coil spring 75 as the flexible cord 70 is extended or retracted from housing interior chamber 24. As depicted in FIG. 8, when cap portion 50 is extended away from housing portion 20, coil spring 75 rotates to tighten and become loaded by forcing the coil springs 75 to wind together and create a retraction load or force onto flexible cord 70. As flexible cord 70 is pulled from housing portion 20, flexible cord unwinds from the interior chamber 24 and winds coil spring 75. The load created can cause cap portion 50 attached to distal end 71 of flexible cord 70 to retract toward housing portion 20 from an extended position when released if not prevented from retracting. Flexible cord 70 will be drawn into interior chamber 24 to wind around coil spring 75 by the load created by the wound coil spring 75, causing the closed end 58 of cap portion 50 to be retained against vertical wall opening 21A.

Once the housing portion 20 is secured to caulking gun 1000 via spring clip 26, a user can extend cap portion 50 and flexible cord 70 to a desired distance as shown in FIG. 9, where cap portion 50 can be placed over the open tip 2011 of the nozzle 2010 as depicted in FIG. 5 to prevent leakage of silicone, latex or other caulking material 1000 during the non-use of the caulking gun. By extending flexible cord 70, a retraction load or force is created inside housing portion 20, which will act to retract flexible cord 70 into the housing interior chamber 24 if the cap portion 50 is removed from open tip 2011.

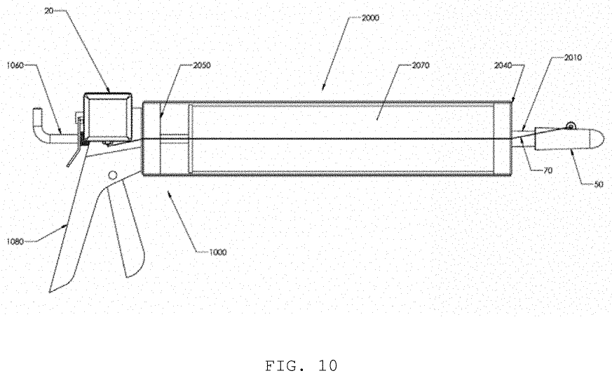

Further details of usage of the caulking tube retractable cap is provided in FIG. 10. As depicted in FIG. 10, caulking gun 1000 includes handle 1080 and ratchet 1060. Housing portion 20 is mounted so as to lie proximate to and between ratchet 1060 and rear end 2050 of caulking tube 2000. Caulking tube 2000 includes cylindrical body 2030 having a rear end 2050 and a front end 2040. Nozzle 2010 extends from front end 2040 and is capped by cap portion 50 to seal caulking material within caulking tube body 2030. Flexible cord 70 attaches to cap portion 50, so that when cap portion 50 is removed from nozzle 2010, flexible cord 70 under tension retracts into housing portion 20 and retain cap portion 50 next to and in contact housing portion 20.

It is within the spirit and scope of this invention for the housing portion 20 to be affixed to the caulking gun 1000 by other commonly known affixing mechanisms including, but not limited to, hook and loop fasteners (Velcro®), adhesive, rivets, buttons or snaps, and magnets. It is also within the spirt and scope of this invention for flexible cord 70 to be any retractable member commonly known including, but not limited to, a cord, a cable, a metal strip, or a strip of plastic. Further, it is within the spirit and scope of this invention for flexible cord 70 to be a stretchable member such as a piece of elastic or another stretchable member. In this alternative embodiment with the stretchable member, the retraction member or other spring would be unnecessary.

Insofar as the description above and the accompanying drawing disclose any additional subject matter that is not within the scope of the single claim below, the inventions are not dedicated to the public and the right to the one or more applications to claim such additional inventions is reserved.

Of course the present invention is not intended to be restricted to any particular form or arrangement, or any specific embodiment, or any specific use, disclosed herein, since the same may be modified in various particulars or relations without departing from the spirit or scope of the claimed invention hereinabove shown and described of which the apparatus or method shown is intended only for illustration and disclosure of an operative embodiment and not to show all of the various forms or modifications in which this invention might be embodied or operated.

The foregoing has described methods and systems for a putty knife or spackle knife holster that are given for illustration and not for limitation and uses. Thus, the inventions are limited only by the appended claims. Although the inventions have been described in accordance with the embodiments shown, one of ordinary skill in the art will readily recognize that there could be variations to the embodiments and those variations would be within the spirit and scope of the present inventions. Accordingly, many modifications may be made by one of ordinary skill in the art without departing from the spirit and scope of the appended claims.

Particular terminology used when describing certain features or aspects of the embodiments should not be taken to imply that the terminology is being redefined herein to be restricted to any specific characteristics, features, or aspects with which that terminology is associated. In general, the terms used in the following claims should not be construed to be limited to the specific embodiments disclosed in the specification, unless the above Detailed Description section explicitly defines such terms. Accordingly, the actual scope of the claims encompasses not only the disclosed embodiments, but also all equivalent ways of practicing or implementing the claimed subject matter.

The above detailed description of the embodiments is not intended to be exhaustive or to limit the disclosure to the precise embodiment or form disclosed herein or to the particular fields of usage mentioned above. While specific embodiments and examples are described above for illustrative purposes, various equivalent modifications are possible within the scope of the disclosure, as those skilled in the relevant art will recognize. Also, the teachings of the embodiments provided herein can be applied to other systems, not necessarily the system described above. The elements and acts of the various embodiments described above can be combined to provide further embodiments.

Any patents, applications and other references that may be listed in accompanying or subsequent filing papers, are incorporated herein by reference. Aspects of embodiments can be modified, if necessary, to employ the systems, functions, and concepts of the various references to provide yet further embodiments.

In light of the above “Detailed Description,” the Inventor may make changes to the disclosure. While the detailed description outlines possible embodiments and discloses the best mode contemplated, no matter how detailed the above appears in text, embodiments may be practiced in a myriad of ways. Thus, implementation details may vary considerably while still being encompassed by the spirit of the embodiments as disclosed by the inventor. As discussed herein, specific terminology used when describing certain features or aspects should not be taken to imply that the terminology is being redefined herein to be restricted to any specific characteristics, features, or aspects of the embodiments with which that terminology is associated.

While certain aspects are presented below in certain claim forms, the inventor contemplates the various aspects in any number of claim forms. Accordingly, the inventor reserves the right to add additional claims after filing the application to pursue such additional claim forms for other aspects.

The above specification, examples and data provide a description of the structure and use of exemplary implementations of the described systems, articles of manufacture and methods. It is important to note that many implementations can be made without departing from the spirit and scope of the disclosure.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS.

Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A caulking gun housing system, configured to retain a caulking gun, comprising:
a securing frame configured to retain an upper end of a caulking gun;
a retaining frame configured to retain a lower end of the caulking gun; and
a holstering device configured to be secured to a user.

2. The caulking gun housing system of claim 1, wherein the securing frame is configured to be slideably attached to the retaining frame.

3. The caulking gun housing system of claim 2, wherein the securing frame is configured to removably attach to the retaining frame via a plurality of rivets configured to insert into one or more rivet holes in the retaining frame.

4. The caulking gun housing system of claim 3, wherein each of the plurality of rivets are positioned underneath the securing frame.

5. The caulking gun housing system of claim 1, wherein the retaining frame is configured to be joined to be continuously joined to the securing frame.

6. The caulking gun housing system of claim 1, wherein the securing frame is a tubular shape.

7. The caulking gun housing system of claim 1, wherein the retaining frame is a tubular shape.

8. The holstering device of claim 1, wherein the holstering device is configured to be removably attached to a belt or belt loop via a latch and hook style holster.

9. The holstering device of claim 1, wherein the retaining frame comprises of an open portion and a closed portion.

10. The holstering device of claim 9, wherein the open portion is flush with the securing portion.

11. The holstering device of claim 9, wherein the closed portion further comprises an enclosed portion configured to protect a nozzle of a caulking gun.

12. The holstering device of claim 11, wherein the closed portion further comprises a cap configured to prevent drippage from the nozzle of the caulking gun from leaking.

13. The holstering device of claim 1, further comprising a secondary retaining device configured to retain a caulking tube retained in the caulking gun, or removed from the caulking gun.

14. The holstering device of claim 1, wherein the retaining frame comprises of a plurality of cord holes, configured to receive and retain a tie cord.

15. The holstering device of claim 14, wherein the tie cord comprises of two ends configured to be tied around the leg of a user.

16. The holstering device of claim 14, wherein the tie cord is a flexible cord comprising of material selected from one or more of:
a cord;
a rope;
nylon;
a metal strip; or
a plastic strip.

17. The holstering device of claim 1, wherein the securing frame is configured to secure a metal rod attached to the upper end of the caulking gun.

18. The holstering device of claim 17, wherein the securing frame is configured to attach to the metal rod of the caulking gun using one or more of:
an adhesive;
a magnet; or
a structural integration selected from one or more of welding or molding.

19. The holstering device of claim 17, wherein the securing frame is configured to attach to the metal rod of the caulking gun using one or more of:
rivets;
buttons; or
snaps.

20. The holstering device of claim 17, wherein the securing frame is configured to attach to the metal rod of the caulking gun using one or more of:
a spring clip; or
a press fit device.
